(19) United States
(12) Patent Application Publication
(10) Pub. No.: US 2023/0278269 A1
(43) Pub. Date: Sep. 7, 2023

(54) INSERT FOR AN INJECTION-MOULDING NOZZLE AND INJECTION-MOULDING NOZZLE HAVING SUCH AN INSERT

(71) Applicant: GÜNTHER Heisskanaltechnik GmbH, Frankenberg (DE)

(72) Inventors: Siegrid Sommer, Burgwald-Ernsthausen (DE); Torsten Schnell, Lichtenfels-Münden (DE)

(21) Appl. No.: 18/179,232

(22) Filed: Mar. 6, 2023

(30) Foreign Application Priority Data
Mar. 7, 2022 (DE) 102022105317.2

(51) Int. Cl. B29C 45/27; B29C 45/03

(52) U.S. Cl. CPC B29C 45/2711; B29C 45/03; B29C 2045/2766; B29C 45/2806

(57) ABSTRACT

An insert for an injection-molding nozzle of an injection-molding device, wherein the injection-molding nozzle has a nozzle body which extends in a longitudinal direction and in which at least one melt duct for a flowable compound to be processed is formed along the longitudinal direction between a first end and a second end, wherein the at least one melt duct opens into a mold impression, formed in the injection mold, of the injection-molding device. The insert has a main body which extends along the longitudinal direction. The main body of the insert has a portion which, in the mounted position of the insert in the injection-molding device, is arranged in the region of the second end of the nozzle body, and a second portion which, in the mounted position of the insert in the injection-molding device, is supported on a tool plate of the injection-molding device.

### CROSS-REFERENCE TO RELATED APPLICATIONS

This non-provisional application claims the benefit of, and priority to, German Application No. 102022105317.2, entitled Insert for an Injection-Moulding Nozzle and Injection-Moulding Nozzle Having Such an Insert, filed on Mar. 7, 2022, which is incorporated by reference in its entirety.

### FIELD OF THE DISCLOSURE

The present disclosure generally relates to an insert for an injection-molding nozzle and to an injection-molding nozzle having the insert.

### BACKGROUND

Injection-molding nozzles, in particular hot runner nozzles or cold runner nozzles, are used in injection molds in order to feed a flowable compound, for example a plastics material, to a separable mold insert under pressure. They usually have a temperature-controllable material tube having a flow duct which is fluidically connected to a distribution duct in a distribution plate via an inlet opening or (in the case of single nozzles) directly to a machine nozzle, and leads out via an outlet opening in the sprue opening of the mold insert (mold impression).

In order that the flowable compound remains temperature controlled as evenly as possible as far as the sprue opening of the mold insert, a heat-conducting sleeve made of highly heat-conductive material is inserted for example into the end of the material tube, said heat-conducting sleeve continuing the flow duct of the material tube and forming an outlet opening for the injection-molding nozzle at its end.

In the case of an open nozzle, the heat-conducting sleeve is usually in the form of a nozzle mouthpiece and provided with a conical nozzle tip. In the case of a needle valve nozzle, the heat-conducting nozzle usually forms a needle guide which serves as a centering body for the shut-off needle and is provided in the region of the outlet opening with a sealing seat for the shut-off needle.

In the processing of abrasive materials, increased wear arises at the heat-conducting sleeve or, if one is not provided, at the material tube, and so the heat-conducting sleeve, the material tube or even the entire nozzle has to be replaced relatively frequently. In the case of needle valve nozzles, wear and damage arise at the centering faces of the needle guide and at the sealing seat of the shut-off needle, such that the latter can no longer close exactly and tightly.

To improve the lifetime of a needle guide, DE 32 45 571 C2 proposes manufacturing it from a wear-resistant material. A problem here, however, is that the wear-resistant material usually has only poor heat-conducting properties. Furthermore, in the event of wear, the entire needle guide has to be replaced.

DE 203 02 845 U1 supplements a heat-conducting sleeve with a separate wear-resistant insert which is arranged so as to be longitudinally movable. The insert has a substantially cylindrical main body with a flange portion, a neck portion and an end portion. The neck portion is inserted into the heat-conducting sleeve while the end portion comes into engagement with the mold insert of the tool. By way of the flange portion, the insert is supported in the tool.

In EP 1 654 105 B1, an additional supporting bush made of a poorly heat-conductive material is provided, with which the insert is support on or in the mold insert. As a result, thermal separation between the wear-resistant insert and the mold insert is achieved. In addition, a further supporting ring is arranged between the material tube and the supporting bush.

Other technical features may be readily apparent to one skilled in the art from the following figures, descriptions and claims.

### SUMMARY

Disclosed is an insert for an injection-molding nozzle, which has been constructed cost-effectively with simple means and provides improved wear protection. The insert should, moreover, not have a negative effect on the temperature control of the flowable compound and, while having a compact design, improves thermal separation between the injection-molding nozzle and the mold insert. Easy handling is also achieved.

In some aspects, the techniques described herein relate to an insert for an injection-molding nozzle of an injection-molding device, wherein the injection-molding nozzle includes a nozzle body which extends in a longitudinal direction and in which at least one melt duct for a flowable compound to be processed is formed along the longitudinal direction between a first end and a second end of the nozzle body, wherein the at least one melt duct opens into a mold impression formed in an injection mold of the injection-molding device, the insert including: a main body which extends along the longitudinal direction, wherein the main body has: a first portion which, in a mounted position of the insert in the injection-molding device, is arranged in a region of the second end of the nozzle body; and a second portion which, in the mounted position of the insert in the injection-molding device, is supported on a tool plate of the injection-molding device, wherein the second portion of the main body has a contact face for contact with the tool plate of the injection-molding device, wherein at least one recess or depression is formed in the contact face.

In some aspects, the techniques described herein relate to an injection-molding nozzle for an injection-molding device, including: a nozzle body which extends in a longitudinal direction, wherein the nozzle body has at least one melt duct for a flowable compound to be processed, wherein the at least one melt duct extends at least partially along the longitudinal direction between a first end and a second end of the nozzle body, and wherein the at least one melt duct opens into a mold impression, formed in an injection mold of the injection-molding device; and an insert including a main body which extends along the longitudinal direction, wherein the main body has: a first portion which, in a mounted position of the insert in the injection-molding device, is arranged in a region of the second end of the nozzle body; and a second portion which, in the mounted position of the insert in the injection-molding device, is supported on a tool plate of the injection-molding device, wherein the second portion of the main body has a contact face for contact with the tool plate of the injection-molding device, wherein at least one recess or depression is formed in the contact face.

### BRIEF DESCRIPTION OF THE DRAWINGS

Further features, details and advantages will become apparent from the wording of the claims and from the following description of exemplary embodiments and the embodiments illustrated by way of example in the drawings, in which:

FIG. 1 shows a perspective view of an insert;

FIG. 2 shows a sectional view of the insert from FIG. 1;

FIG. 3 shows a schematic partial sectional view of an injection-molding nozzle with another embodiment of an insert;

FIG. 4 shows a sectional view of another embodiment of an insert;

FIG. 5a shows a sectional view of a further embodiment of an insert according to the invention with a support ring;

FIG. 5b shows a perspective view of the insert in FIG. 5a with the support ring removed;

FIG. 5c shows a perspective view of a variant of the insert in FIGS. 5a and 5b;

FIG. 6 shows a sectional view of another embodiment of an insert;

FIG. 7 shows a sectional view of another embodiment of an insert; and

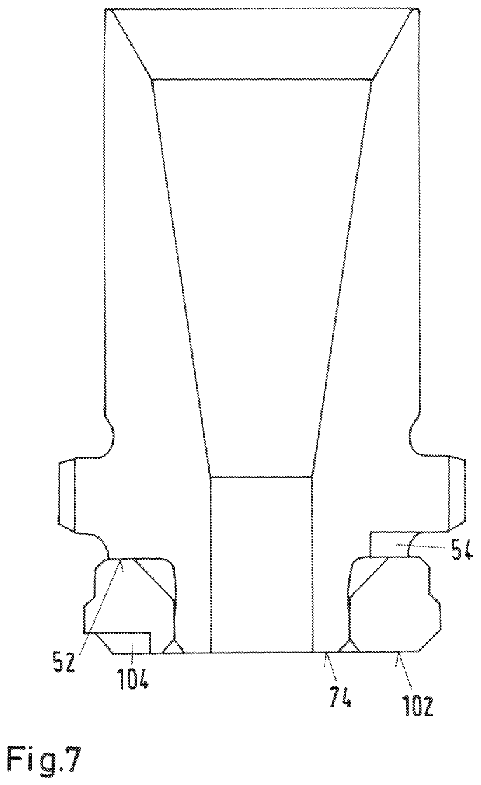

FIG. 8 shows a sectional view of another embodiment of an insert.

### DETAILED DESCRIPTION

Disclosed is an insert for an injection-molding nozzle of an injection-molding device, wherein the injection-molding nozzle has a nozzle body which extends in a longitudinal direction and in which at least one melt duct for a flowable compound to be processed is formed along the longitudinal direction between a first end and a second end, wherein the at least one melt duct opens into a mold impression, formed in the injection mold, of the injection-molding device. The insert has a main body which extends along the longitudinal direction, wherein the main body has a portion which, in the mounted position of the insert in the injection-molding device, is arranged in the region of the second end of the nozzle body, and wherein the main body has a second portion which, in the mounted position of the insert in the injection-molding device, is supported on a tool plate of the injection-molding device. In aspects, the second portion of the main body has a contact face, wherein at least one recess or depression is formed in the contact face.

The at least one recess or depression in the contact face of the second portion of the main body ensures that the thermal separation between the injection-molding nozzle and injection mold, in particular between the injection-molding nozzle and mold impression, can avoid heat losses in the sprue region. More heat passes in a targeted manner into the gating point of the injection-molding nozzle, such that the flowable compound to be processed always remains reliably flowable right into the gating point and does not solidify.

The main body of the insert has a simple structure and can be produced cost-effectively. On account of the recesses or depressions introduced into the contact face of the second portion of the main body, the temperature of the flowable compound in the melt duct is controlled with simple means.

The main body of the insert at least partially continues the at least one melt duct of the nozzle body such that the flowable compound to be processes passes reliably into the mold impression. To this end, at least one melt duct is formed in the main body of the insert.

In aspects, the second portion of the main body is a flange or is formed in a flange-like manner, wherein the second portion of the main body has a circumferential edge or a circumferential face. This is formed in a cylindrical manner, just like the main body. The flange-like design ensures good support for the insert in the tool.

The contact face of the second portion of the main body is oriented perpendicularly to the longitudinal direction, such that the insert is always supported reliably in the injection mold. In aspects, the contact face of the second portion of the main body is an end face which provides the insert with improved retention. Particularly, the contact face of the second portion of the main body is an end face of the flange, which is thus supported evenly in the injection mold. In this case, the contact face of the second portion of the main body may be a circumferential face, for example a ring face.

In aspects, the contact face of the second portion of the main body is formed at least partially in a stepped manner. This too allows the contact face of the insert to be designed very precisely with respect to the tool, in order to create improved thermal separation for the particular use. For example, the contact face of the second portion of the main body is formed in a stepped manner radially with respect to the longitudinal direction.

The thermal separation can be further improved when at least two recesses or depressions are provided in the contact face. The recesses or depressions may be spaced apart regularly or irregularly in the contact face, having a favorable effect on the thermal contact between the insert and the tool. The fact that the recesses or depressions in the contact face extend in a radial direction R perpendicularly to the longitudinal direction or that the recesses in the contact face are formed in a pocket-like or segment-like manner may also contribute thereto.

The thermal separation of the insert and injection mold can be further improved when the recesses or depressions in the contact face are open towards the circumferential face of the second portion. The flange thus has lateral recesses or openings which minimize the heat transfer from the insert and thus from the injection-molding nozzle to the injection mold in the region of the mold impression in a targeted manner. Bearing webs or bearing segments which extend in a radial and/or circumferential direction and form a defined contact region are thus formed between the recesses or depressions in the contact face.

In aspects, the circumferential edge or the circumferential face of the second portion is provided at least partially with a thread. It is possible for a tool, for example, to be screwed onto this thread in order for it to be possible to remove the insert quickly and comfortably from the injection-molding nozzle and thus out of the injection mold without the injection-molding nozzle itself or its nozzle body needing to be removed from the injection mold. The handling of the insert is thus easy and always reliable.

In this case, it is favorable for the handling of the insert when the outside diameter of the first portion is smaller than the outside diameter of the second portion, namely when the outside diameter of the second portion in the form of a flange is larger than the outside diameter of the first portion. The insert can be handled easily and reliable during installation and removal. The recesses or depressions ensure as little thermal contact as possible between the flange and tool.

In structural terms, it is favorable when the first portion of the main body is a neck portion or forms a neck portion which is insertable into the nozzle body, is able to be attached to the nozzle body or is able to be placed externally on the nozzle body. This too has a favorable effect on handling.

In aspects, the main body has a third portion which, in the mounted position of the insert in the injection-molding device, is arranged in the region of the mold impression of the injection-molding device. This further improves the positioning and orientation of the insert in the injection mold.

The third portion of the main body ends ahead of the mold impression of the injection mold in the tool plate, or the third portion extends as far as the mold impression and forms, with its end face, a part of the mold impression. Here, it is advantageous when the third portion of the main body is formed at least partially in a narrowed manner at its outer circumference in the longitudinal direction. This too allows the heat transfer from the insert to the tool or to the mold impression to be improved.

When the third portion of the main body is formed at least partially in a stepped manner at its outer circumference in the longitudinal direction, in particular when the outside diameter of the third portion of the main body becomes smaller progressively and/or in steps towards the mold impression, this also contributes thereto. In this case, the third portion may, if required, be formed at least partially in a conical manner in the longitudinal direction.

For a compact design of the insert and for the handling thereof, it is favorable when the second portion of the main body is formed between the first portion and the third portion in the longitudinal direction.

In aspects, the insert has a support ring or is provided with a support ring, wherein the support ring bears with a first end face against the contact face of the second portion of the main body and forms, at a second end face, a contact face for contact with the tool plate of the injection-molding device, wherein at least one recess or depression is formed in the contact face. As a result, the thermal contact between the insert and the mold impression of the injection-molding device can be further improved. The support ring thus forms an insulation ring.

In aspects, the support ring has a circumferential edge or a circumferential face and bears against the contact face of the second portion of the main body with the first end face in the longitudinal direction. Thus, in the installed state of the insert or when the insert is being used as intended, the support ring is located between the second portion of the main body and the tool plate of the injection-molding device. Consequently, in the mounted position in the injection-molding device, the main body of the insert is supported against the tool plate of the injection-molding device via the support ring.

In this case, it is advantageous when the second end face of the support ring forms a contact face in which at least one recess or depression is formed. This at least one recess or depression in the contact face of the support ring likewise ensures that the thermal separation between the injection-molding nozzle and injection mold, in particular between the injection-molding nozzle and mold impression, can be configured very precisely in order to avoid heat losses in the sprue region.

The at least one recess or depression in the support ring is arranged or designed in the same way as the at least one recess or depression in the second portion of the main body of the insert. Therefore, reference is expressly made to the information given above in relation thereto.

In structural terms, it is favorable when the support ring surrounds the third portion of the main body, wherein the inside diameter of the support ring may correspond to the outside diameter of the third portion of the main body apart from a defined clearance for movement. Alternatively, it is provided that the inside diameter of the support ring is larger than the outside diameter of the third portion of the main body. This too has an influence on the heat transfer, which can be configured precisely by an insert so as to be configured for the particular application.

A further embodiment provides that the support ring is provided at least partially with an internal thread, wherein the support ring can be screwed with this internal thread onto the thread of the second portion of the main body.

According to yet another embodiment, it is provided that the contact face of the support ring and an end face, facing the mold impression of the injection-molding device, of the third portion of the main body are formed in a flush manner.

In order, when processing abrasive compounds, to ensure a long service life of the insert, the main body comprises a wear-resistant material with regard to the flowable compound to be processed.

In order to further improve the heat transfer, it is provided that the support ring consists, as an insulation ring, of a poorly heat-conductive material, for example titanium.

Also disclosed is an injection-molding nozzle for an injection-molding device, having a nozzle body which extends in a longitudinal direction, having at least one melt duct for a flowable compound to be processed, wherein the melt duct extends at least partially along the longitudinal direction between a first and end a second end of the nozzle body, and wherein the melt duct opens into a mold impression, formed in the injection mold, of the injection-molding device, and having an insert as set out above.

This insert is advantageously arranged or designed to be longitudinally movable relative to the nozzle body such that thermal expansions of the injection-molding nozzle and of the injection mold can be taken into account.

In aspects, the insert has been inserted into the nozzle body, wherein the first portion of the main body is arranged in the nozzle body so as to be longitudinally movable. In an alternative embodiment, it is provided that the insert has been placed on the nozzle body, wherein the first portion of the main body is arranged on the nozzle body so as to be longitudinally movable.

For improved temperature control of the flowable compound, a heat-conducting sleeve that continues the melt duct is formed in the nozzle body, wherein the heat-conducting sleeve comprises a highly heat-conductive material.

It is advantageous here when the insert has been inserted into the heat-conducting sleeve of the nozzle body, wherein the first portion of the main body is arranged in the heat-conducting sleeve so as to be longitudinally movable.

In an advantageous alternative embodiment, the insert may have been placed on the heat-conducting sleeve so as to be longitudinally movable, wherein the insert is arranged on the heat-conducting sleeve with the first portion so as to be longitudinally movable.

A further design provides that the first portion of the main body is provided with a thread which is engaged with the heat-conducting sleeve.

A further embodiment provides that the heat-conducting sleeve is fixed in the nozzle body by means of a securing sleeve. This securing sleeve is screwed into the nozzle body for example after the heat-conducting sleeve has been inserted. The insert has now been placed at least partially on the securing sleeve with the first portion.

In this case, it may also be provided that the first portion of the main body is provided with a thread which is engaged with an associated portion of the securing sleeve.

Depending on the application, the injection-molding nozzle is a hot runner nozzle or a cold runner nozzle.

It is also provided that the injection-molding nozzle is or forms a needle valve nozzle, wherein the needle valve nozzle has a shut-off needle. In this case, the insert forms a centering body for the shut-off needle, wherein the melt duct in the main body of the insert may be formed at least partially in a conical manner in cross section and in the longitudinal direction.

If the injection-molding nozzle is a needle valve nozzle, this also has the advantage that the insert additionally acts as a centering body because the needle is guided precisely and in a positionally stable manner within the insert. As a result of the improved position, the needle guide can also be further improved. As a result, damage to the shut-off needle but also wear phenomena on the injection-molding nozzle is/are reduced.

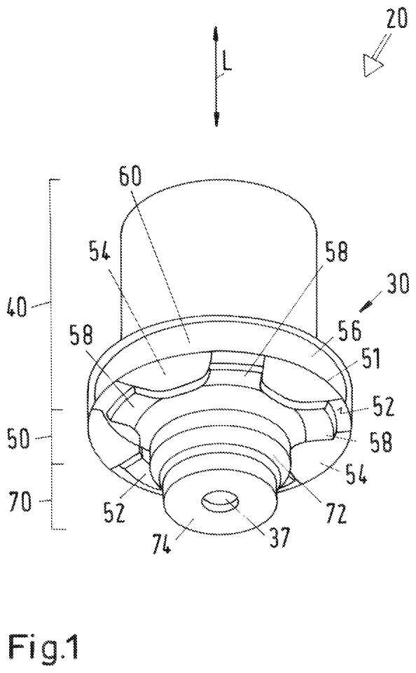

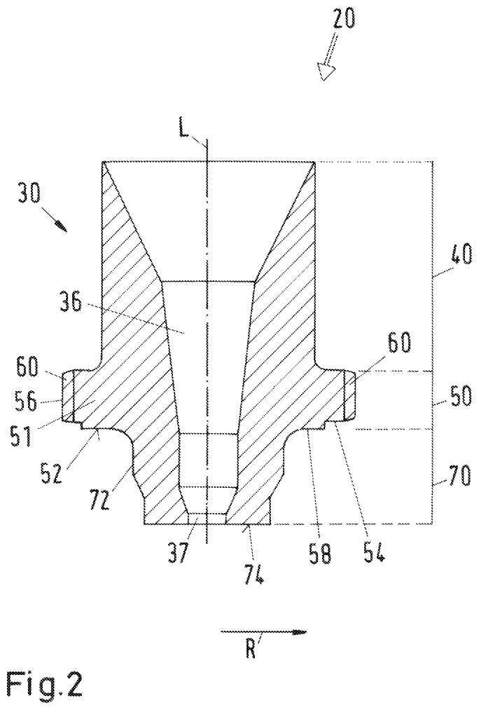

The insert denoted generally by 20 in FIG. 1 is intended for use in an injection-molding nozzle 10 of an injection-molding device. It has a main body 30 which extends along a longitudinal direction L and is subdivided into a plurality of portions 40, 50, 70. Centrally, the main body 30 has a melt duct 36, which is formed partially in a conical manner, and which ends in an outlet opening 37 (see also FIG. 2 in this regard).

A first portion 40 of the main body 30 forms a neck portion, which, in the mounted position of the insert 20, has been inserted into the end of a nozzle body 12 of the injection-molding nozzle 10.

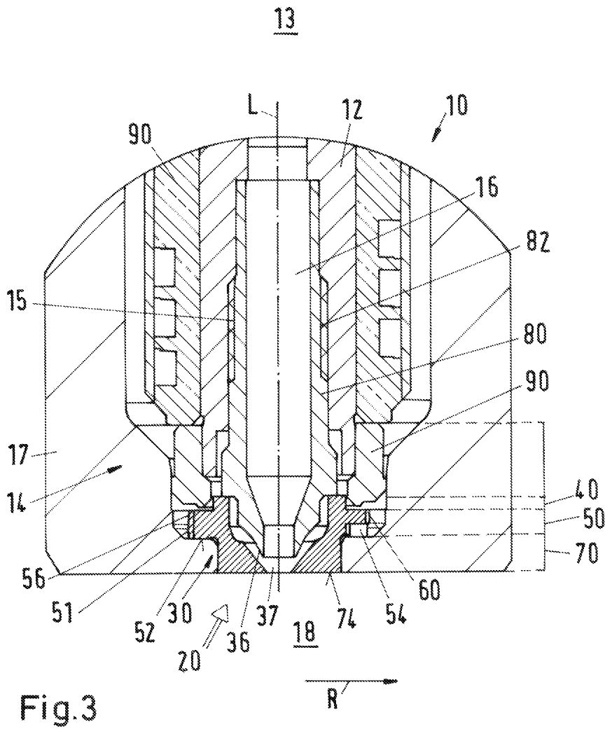

A second portion 50 immediately adjoins the first portion 40 and forms a flange, which, in the mounted position of the insert 20 in the injection-molding device, is supported in the direction of the mold impression 18 on a tool plate 17 (schematically indicated in FIG. 3) of the injection-molding device. It is apparent from FIGS. 1 and 2 that, in this exemplary embodiment, the outside diameter of the first portion 40 is smaller than the outside diameter of the second portion 50.

The flange 50 has a cylindrical circumferential face 56 and a contact face 52, which is oriented perpendicularly to the longitudinal direction L and thus forms an end face for the flange 50. This end face 52 is provided for contact with the tool plate 17, such that the insert 20, when used as intended, can be supported via the contact face 52 on the tool plate 17 of the injection-molding device, while the neck portion of the first portion 40 passes into the nozzle body 12.

In order to improve the thermal contact of the insert 20 with the injection mold, a plurality of recesses or depressions 54 are formed in the circumferential contact face or end face 52 of the second portion 50. These recesses or depressions extend outwardly in a radial direction R and are designed to be open towards the circumferential face 56. The depressions 54 are also spaced apart regularly in the circumferential direction such that bearing webs 58 are formed in between. As a result of the recesses or depressions 54, which may also be formed in a pocket-like or segment-like manner, the contact area of the insert 20 with the tool plate 17 of the injection mold is reduced in a targeted manner, thereby reducing the heat transfer from a heated injection-molding nozzle 10 to the injection mold in a targeted manner.

The end face 52 and thus the bearing webs 58 thereof are also formed in a stepped manner in a radial direction R, with the result that the contact area of the insert 20 with the tool plate 17 is reduced even further. Nevertheless, the bearing webs 58 between the recesses or depressions 54 provide the insert 20 with sufficient support in the tool, such that the insert is securely positioned.

In order for it to be possible to withdraw the insert 20 quickly and comfortably from the nozzle body 12 of the injection-molding nozzle 10, for example when the nozzle 20 needs to be changed and replaced with a new one, the circumferential face 56 of the second portion 50 and thus of the flange is provided with a thread 60. A tool (not illustrated) may be attached to this thread 60 if required.

As FIGS. 1 and 2 also show, the main body 30 of the insert 20 has a third portion 70, which, in the mounted position of the insert 20 in the injection-molding device, is arranged in the region of the mold impression 18 of the injection-molding device. The third portion 70 has an outer circumference 72 and, perpendicularly to the longitudinal axis L, an end face 74 which faces the mold impression 18.

In aspects, the insert 20 is inserted with the third portion 70, which is likewise diametrically smaller than the second flange portion 50, into the tool plate 17, which, for this purpose, is provided with a suitable recess (not indicated in more detail). Provision may be made here for the third portion 70 to end in or to project through the tool plate 17 and to form, with its end face 74, a wall portion of the mold impression 18.

To improve the heat transfer from the nozzle to the tool, the third portion 70 of the insert 20 is formed at least partially in a stepped manner in the longitudinal direction L. As a result, the insert 20 can also be centered and sealed off in the injection mold.

In order to increase the service life of the insert 20 and thus of the injection-molding nozzle 10, the main body 30 is manufactured from a wear-resistant material with regard to the flowable compound to be processed. Furthermore, the second portion 50 of the main body 30 is formed, in the longitudinal direction L, as a flange between the first portion 40 and the third portion 70, such that the insert as a whole is extremely compact and is easy to handle.

The injection-molding nozzle 10 has, as shown for example in FIG. 3, a nozzle body 12, which extends in the longitudinal direction L and forms a material tube for the flowable compound to be processed. Provided in the material tube 12 is a melt duct 16, wherein the melt duct 16 extends at least partially along the longitudinal direction L between a first end 13 (not shown) and a second end 14 of the nozzle body 12. The melt duct 16 opens into a mold impression 18 (not illustrated in more detail) of the injection mold. Mounted on the material tube of the nozzle body 12 is a heating device 19, which brings the compound conveyed in the melt duct 16 to and keeps it at a predefined temperature.

Inserted in the region of the second end 14 of the nozzle body 12 is a heat-conducting sleeve 80, which can include of a highly heat-conductive material. The heat-conducting sleeve 80 may have been inserted into the nozzle body 12 so as to be longitudinally movable. However, it may also—as shown in FIG. 3—have been screwed into the nozzle body 12. To this end, the heat-conducting sleeve 80 is provided on its outer circumference with a threaded portion 82, while a corresponding thread 15 is formed in the nozzle body 12.

The insert 20, as illustrated in FIGS. 1 and 2, is either inserted with its first portion 40 directly into the nozzle body 12 or into the heat-conducting sleeve 80 of the nozzle body 12, wherein this first portion 40 of the main body 30 is guided in the heat-conducting sleeve 80 so as to be longitudinally movable. In this case, the main body 30 of the insert 20 continues the melt duct 16 of the nozzle body 12 with its duct 36.

In the embodiment in FIG. 3, the insert 20 has not been inserted with a neck portion 40 into the heat-conducting sleeve 80. The first portion 40 of the main body 30 has a larger diameter here and externally surrounds the heat-conducting sleeve 80. In addition, the insert 20 is supplemented by a support ring 90, which at least partially engages around the outer circumference of the nozzle body 12 and thus of the material tube. In aspects, the support ring 90 forms an insulation ring.

In another embodiment (not illustrated), the insert 20 and the support ring 90 may be formed in one piece.

The injection-molding nozzle 12 may be in the form of a hot runner nozzle or of a cold runner nozzle. Furthermore, the injection-molding nozzle 12 may be configured as an open nozzle or of a needle valve nozzle. In this case, the insert 20 forms a centering body for a shut-off needle (not shown).

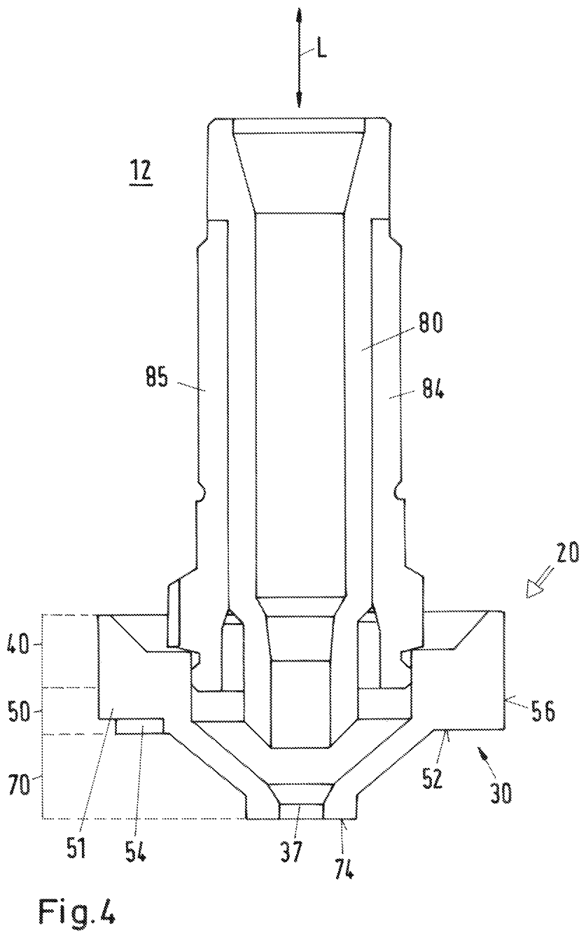

In the embodiment illustrated in FIG. 4, a heat-conducting sleeve 80 has likewise been inserted into the nozzle body 12 of the injection-molding nozzle 10 (not illustrated in more detail), said heat-conducting sleeve being secured in the nozzle body 12 by a securing sleeve 84. The securing sleeve 84 at least partially surrounds the heat-conducting sleeve 80 and is screwed with an external thread 85 into the nozzle body 12 such that the heat-conducting sleeve 80 is fixed in the longitudinal direction L. To this end, the nozzle body 12 is provided with a corresponding internal thread.

The insert likewise denoted by 20 in FIG. 4 has a main body 30 which extends along a longitudinal direction L and is subdivided into the portions 40, 50, 70. Formed centrally in the main body 30 is a melt duct 36, which is formed partially in a conical manner, and which ends in an outlet opening 37 (see also FIG. 2 in this regard).

The first portion 40 and the second portion 50 of the main body 30 are diametrically larger than the third portion 70, wherein the inside diameter of the first portion 40 is dimensioned such that the securing sleeve 84 at least partially surrounds the heat-conducting sleeve 80.

Here too, the second portion 50 immediately adjoins the first portion 40 and forms a flange, which, in the mounted position of the insert 20 in the injection-molding device, is supported in the direction of the mold impression 18 on the tool plate 17 of the injection-molding device. The flange 50 has a substantially cylindrical circumferential face 56 and a contact face 52, which is oriented perpendicularly to the longitudinal direction L and thus forms an end face for the flange 50. This end face 52 is provided for contact with the tool plate 17, such that the insert 20, when used as intended, can be supported via the contact face 52 on the tool plate 17 of the injection-molding device, while the first portion 40 is located in the region of the securing sleeve 84 and at least partially surrounds the latter.

In order, in this embodiment too, to reduce the thermal contact of the insert 20 with the injection mold, a plurality of recesses or depressions 54 are formed in the circumferential contact face or end face 52 of the second portion 50. These may—as in the previous exemplary embodiment—extend outwardly in a radial direction R, wherein, here too, the recesses or depressions 54 are designed to be open towards the circumferential face 56. The depressions 54 may be spaced apart regularly or irregularly in the circumferential direction such that bearing webs 58 are formed, which may, here too, be stepped if required, in order for it to be possible to precisely define the contact face of the insert. The recesses or depressions 54 themselves are formed discretely, for example, in a pocket-like or segment-like manner.

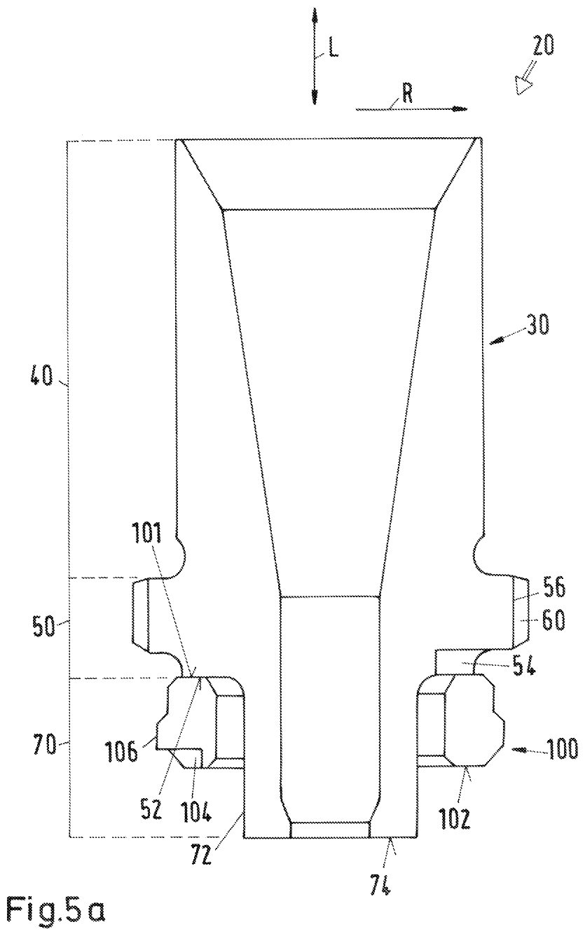

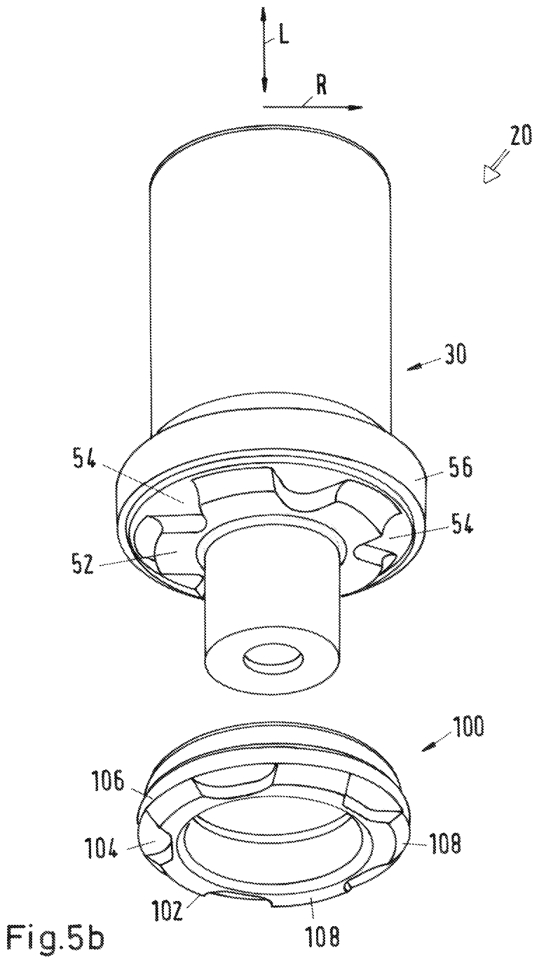

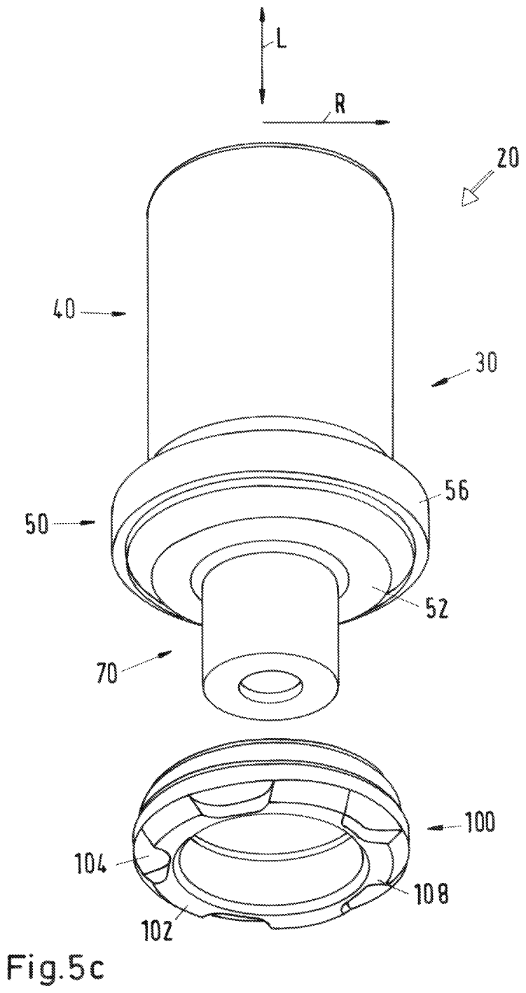

FIGS. 5a and 5b show a further embodiment of an insert 20. This corresponds initially in terms of its basic shape to the embodiment in FIGS. 1 and 2, meaning that the insert 20 has a main body 30 with a plurality of portions 40, 50, 70, wherein the middle portion 50 forms a flange which has a contact and end face 52 in the direction of the mold impression 18.

Formed in the contact face or end face 52 of the second portion 50 are a plurality of recesses or depressions 54, which can extend outwardly in a radial direction R. The recesses or depressions 54 are designed in a pocket-like or hollow-like manner and, here too, are designed to be open towards the circumferential face 56 of the flange 50 in order to define the thermal contact area of the insert 20 with respect to the tool plate 17 of the injection mold in a targeted manner.

Beneath the second portion 50 of the insert 20, a support ring 100 is arranged at the level of the third portion 70. Said support ring has a circumferential edge or a circumferential face 106 and an inside diameter (not indicated) which is larger than the outside diameter of the outer circumference 72 of the third portion 70. The support ring or insulation ring 100 also has, perpendicularly to the longitudinal axis L, a first end face 101, which is oriented in the direction of the first portion 40 of the insert 20, and an opposite second end face 102, with which, in the mounted position of the insert 20, the support ring 100 is supported on the tool plate 17 of the injection-molding device.

It is apparent that the insert 20, when used as intended, is supported via the support ring 100 and the contact face 102 thereof on the tool plate 17 of the injection-molding device, while the neck portion of the first portion 40 fits on the opposite side in the nozzle body 12 and is mounted so as to be longitudinally movable therein.

In order for it to be possible to precisely set the thermal contact of the support ring 100 and thus also of the insert 20 with the injection mold, a plurality of recesses or depressions 104 are formed in the circumferential contact face or end face 102 of the support ring 100. These recesses or depressions extend outwardly in a radial direction R and are designed to be open towards the circumferential face 106. The depressions 104 may be spaced apart regularly in the circumferential direction here too, such that bearing webs 108 are formed in between. As a result of the recesses or depressions 104, which may also be formed in a pocket-like or segment-like manner, the contact area of the support ring 100 and thus the contact of the insert 20 with the tool plate 17 of the injection mold can be defined very precisely, thereby reducing the heat transfer from a heated injection-molding nozzle 10 to the injection mold in a targeted manner.

The end face 102 and the bearing webs 108 thereof may be formed in a stepped or, as shown in FIG. 5b, oblique manner in the radial direction R, with the result that the contact area with the tool plate 17 can be defined even more precisely.

The design of the insert 20 in FIG. 5c corresponds substantially to the design in FIGS. 5a and 5b. However, the contact face or end face 52 of the second portion 50 of the main body 30 is not provided with a plurality of recesses or depressions 54 here. The second portion 50 of the main body bears with its entire contact face 52 on the first end face 101 of the support ring 100.

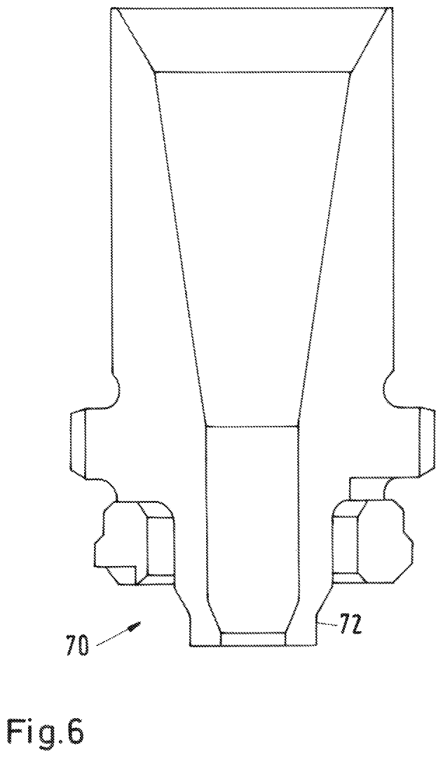

FIG. 6 shows an alternative configuration of the third portion 70 of the main body 30.

While the third portion 70, in the embodiment in FIGS. 5a to 5c, is cylindrical as a whole and has a constant outside diameter along the longitudinal axis L, the third portion 70 of the main body 30 in FIG. 6 is formed at least partially in a narrowed manner at its outer circumference 72 in the longitudinal direction L, to improve the heat transfer from the insert 20 to the tool or to the mold impression.

In the embodiment of an insert 20 having a support ring 100, it is provided that the third portion 70 ends with its end face 74 at the same level as the second end face or contact face 102 of the support ring. Both faces thus lie flush in a plane.

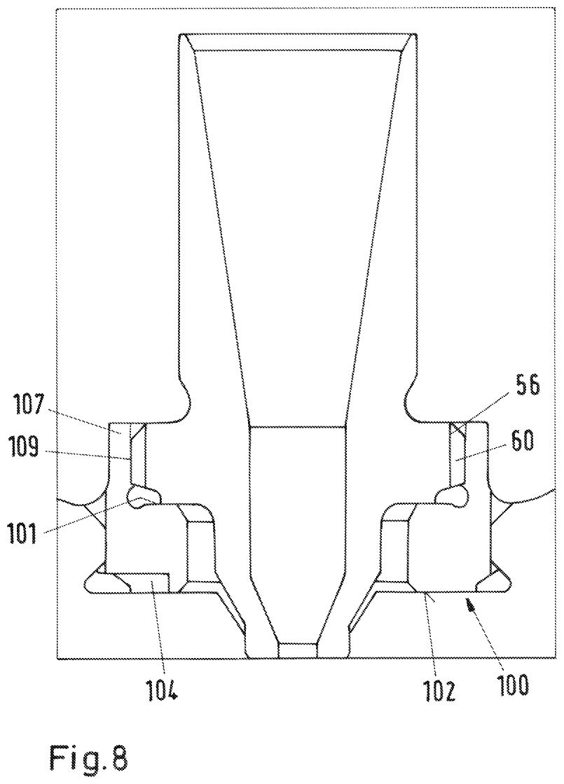

In FIG. 8, the support ring 100 is fixedly connected to the main body 30.

For example, for this, the support ring 100 carries over the first end face 101 an edge 107 which is provided on its inner circumference with a thread 109. By way of this thread 109, the support ring 100 can be screwed onto the thread 60 on the circumference edge or on the circumferential face 56 of the second portion 50. It is also conceivable to form some other connection, for example a bayonet connection or a latching connection.

In aspects, the insert 20 is inserted with its first portion 40 not as a neck portion into the nozzle body 12 of the injection-molding nozzle 10. Rather, the first portion is designed such that it is either placed at least partially on the nozzle body 12 or—as shown in FIG. 4—onto the heat-conducting sleeve 80 or the fixing element 84 thereof. In this case, it may also be expedient for the outside diameter of the first portion 40 to be larger than the outside diameter of the second portion 50.

In aspects, an insert 20 for an injection-molding nozzle 10 of an injection-molding device, wherein the injection-molding nozzle 10 has a nozzle body 12 which extends in a longitudinal direction L and in which at least one melt duct 16 for a flowable compound to be processed is formed along the longitudinal direction L between a first end 13 and a second end 14, wherein the at least one melt duct 16 opens into a mold impression 18, formed in the injection mold, of the injection-molding device. The insert 20 has a main body 30 which extends along the longitudinal direction L. The main body 30 of the insert 20 has a portion 40 which, in the mounted position of the insert 20 in the injection-molding device, is arranged in the region of the second end 14 of the nozzle body 12, and a second portion 50 which, in the mounted position of the insert 20 in the injection-molding device, is supported on a tool plate 17 of the injection-molding device. In aspects, good wear protection for the injection-molding nozzle and temperature control of the flowable compound conveyed in the injection-molding nozzle is achieved when the second portion 50 of the main body 30 has a contact face 52 for contact with the tool plate 17 of the injection-molding device, wherein at least one recess or depression 54 is formed in the contact face 52.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An insert for an injection-molding nozzle of an injection-molding device, wherein the injection-molding nozzle comprises a nozzle body which extends in a longitudinal direction and in which at least one melt duct for a flowable compound to be processed is formed along the longitudinal direction between a first end and a second end of the nozzle body, wherein the at least one melt duct opens into a mold impression formed in an injection mold of the injection-molding device, the insert comprising:
a main body which extends along the longitudinal direction, wherein the main body has:
a first portion which, in a mounted position of the insert in the injection-molding device, is arranged in a region of the second end of the nozzle body; and
a second portion which, in the mounted position of the insert in the injection-molding device, is supported on a tool plate of the injection-molding device, wherein the second portion of the main body has a contact face for contact with the tool plate of the injection-molding device, wherein at least one recess or depression is formed in the contact face.

2. The insert of claim 1, wherein the second portion of the main body is a flange or is formed in a flange-like manner, wherein the second portion of the main body has a circumferential edge or a circumferential face.

3. The insert of claim 2, wherein the circumferential edge or the circumferential face of the second portion is provided at least partially with a thread.

4. The insert of claim 1, wherein the contact face of the second portion of the main body is formed at least partially in a stepped manner.

5. The insert of claim 1, wherein at least two recesses or depressions are provided in the contact face, wherein the at least two recesses or depressions are formed in a pocket-like or segment-like manner.

6. The insert of claim 1, wherein at least two recesses or depressions are provided in the contact face, wherein the at least two recesses or depressions extend in a radial direction perpendicularly to the longitudinal direction in the contact face.

7. The insert of claim 1, wherein the second portion of the main body has a circumferential edge or a circumferential face, wherein at least two recesses or depressions are provided in the contact face, wherein the at least two recesses or depressions in the contact face are open towards the circumferential face of the second portion.

8. The insert of claim 1, wherein the main body has a third portion which, in the mounted position of the insert in the injection-molding device, is arranged in the region of the mold impression of the injection-molding device.

9. The insert of claim 8, wherein the third portion of the main body is formed at least partially in a narrowed manner at its outer circumference in the longitudinal direction.

10. The insert of claim 1, wherein the insert has a support ring or is provided with a support ring, wherein the support ring bears with a first end face against the contact face of the second portion of the main body and forms, at a second end face, a support ring contact face for contact with the tool plate of the injection-molding device, wherein at least one recess or depression is formed in the support ring contact face.

11. The insert of claim 10, wherein the support ring contact face of the support ring is formed at least partially in a stepped manner.

12. The insert of claim 10, wherein at least two recesses or depressions are provided in the support ring contact face, wherein the at least two recesses or depressions are formed in a pocket-like or segment-like manner.

13. The insert of claim 10, wherein at least two recesses or depressions are provided in the support ring contact face, wherein the at least two recesses or depressions extend in a radial direction perpendicularly to the longitudinal direction in the support ring contact face.

14. An injection-molding nozzle for an injection-molding device, comprising:
a nozzle body which extends in a longitudinal direction, wherein the nozzle body has at least one melt duct for a flowable compound to be processed, wherein the at least one melt duct extends at least partially along the longitudinal direction between a first end and a second end of the nozzle body, and wherein the at least one melt duct opens into a mold impression, formed in an injection mold of the injection-molding device; and
an insert comprising a main body which extends along the longitudinal direction, wherein the main body has:
a first portion which, in a mounted position of the insert in the injection-molding device, is arranged in a region of the second end of the nozzle body; and
a second portion which, in the mounted position of the insert in the injection-molding device, is supported on a tool plate of the injection-molding device, wherein the second portion of the main body has a contact face for contact with the tool plate of the injection-molding device, wherein at least one recess or depression is formed in the contact face.

15. The injection-molding nozzle of claim 14, wherein the insert is configured to be longitudinally movable relative to the nozzle body.

16. The injection-molding nozzle of claim 14, wherein the nozzle body comprises a heat-conducting sleeve which continues the at least one melt duct.

17. The injection-molding nozzle of claim 16, wherein the insert is inserted into the heat-conducting sleeve of the nozzle body, wherein the first portion of the main body is arranged so as to be longitudinally movable in the heat-conducting sleeve.

18. The injection-molding nozzle of claim 16, wherein the insert has been placed on the heat-conducting sleeve of the nozzle body and/or onto a securing sleeve fixing the heat-conducting sleeve in the nozzle body, wherein the first portion of the main body is arranged so as to be longitudinally movable on the heat-conducting sleeve or the securing sleeve.

19. The injection-molding nozzle of claim 14, wherein the insert has a support ring or is provided with a support ring, wherein the support ring bears with a first end face against the contact face of the second portion of the main body and forms, at a second end face, a support ring contact face for contact with the tool plate of the injection-molding device, wherein at least one recess or depression is formed in the support ring contact face.

20. The injection-molding nozzle of claim 19, wherein the support ring contact face of the support ring i) is formed at least partially in a stepped manner, ii) has at least two recesses or depressions in the support ring contact face, wherein the at least two recesses or depressions are formed in a pocket-like or segment-like manner, or iii) has at least two recesses or depressions in the support ring contact face, wherein the at least two recesses or depressions extend in a radial direction perpendicularly to the longitudinal direction in the support ring contact face.
